(19) United States
(12) Patent Application Publication
(10) Pub. No.: US 2011/0056286 A1
(43) Pub. Date: Mar. 10, 2011

(54) DEVICE AND METHOD FOR MEASURING A QUANTITY OVER A SPATIAL REGION

(76) Inventor: Peter Alexander Jansen, Hamilton (CA)

(21) Appl. No.: 12/873,897

(22) Filed: Sep. 1, 2010

Related U.S. Application Data
(60) Provisional application No. 61/241,169, filed on Sep. 10, 2009.

(51) Int. Cl. G01F 17/00

(52) U.S. Cl. 73/149

(57) ABSTRACT

The present invention enables the measurement and determination of a quantity over a selected spatial region by providing a device that incorporates a sensor for the measurement of the quantity and a spatial subsystem for determining the spatial information comprising a spatial position and/or orientation of the device when the measurement is made. A processing module integrated with the device operates on a dataset of multiple measurements correlated with spatial information and provides a determination of the quantity over the selected spatial range, either directly based on the measured data point and the spatial information or via a sensor fusion algorithm such as an interpolation algorithm. The results may be displayed on the device, for example, on a graphical display, or may be transmitted to a remote processor for subsequent processing and/or display.

This application claims the benefit of U.S. Provisional Application No. 61241169, filed 10 Sep. 2009.

### FIELD OF THE INVENTION

This invention relates to sensors and sensor fusion systems. More particularly, the invention relates sensing devices incorporating systems for correlating measurements with spatial and orientation information of a device.

### BACKGROUND OF THE INVENTION

“Sensor fusion” is a research area in electrical engineering that examines how the output of multiple sensors can be combined to yield either more accurate results, or results that could otherwise not have been obtained by any single sensor for which data is being combined. Typically this can take many forms, including “fusing” the output from many cameras overlooking an arbitrary environment to attempt to determine the location of people in that environment. A more common application of sensor fusion is the idea of “inertial measurement systems”, where the output from several different sensors designed to measure specific spatial phenomena (such as rotation, or acceleration) are combined to try and determine both the position and orientation of a given object in space. In these cases, the “inertial measurement unit” is physically attached to the object in motion, such that external points of reference aren't necessarily required to determine that objects location. “Inertial measurement units” are often used, for example, in military rockets or missiles as a major component of their guidance systems.

Unfortunately, many sensor systems employ complex sensor networks, expensive hardware such as arrayed sensors, and sophisticated algorithms that are too costly or impractical to be used in many practical settings. What is therefore needed is a sensor fusion device that uses simple, inexpensive hardware to provide a powerful yet practical sensing solution.

### SUMMARY OF THE INVENTION

The present invention addresses this shortcoming of the prior art by providing devices and methods that enable the economical and practical measurement of a quantity over a selected spatial region by fusing a sensor and a spatial subsystem in a single device.

Accordingly, in a preferred embodiment, the present invention provides a measurement device comprising:

a sensor;

a spatial subsystem for determining, at a time substantially simultaneous with a measurement of a quantity by the sensor, spatial information comprising one of a position of the device relative to a reference position, an orientation of the device relative to a reference orientation, and a combination thereof;

a power source;

a user interface;

a housing; and

a processing subsystem comprising a processor and memory;

wherein the processing subsystem is adapted to provide, based on a dataset comprising measurements of the quantity made by the sensor and the spatial information provided by the spatial subsystem, a determination of the quantity over a selected spatial region.

In a preferred embodiment, the present invention provides devices and methods for utilizing simple, inexpensive, single-pixel sensors for spatially mapping a quantity over a selected spatial zone.

In another aspect of the invention, there is provided a method of measuring a quantity over a selected spatial region with a device comprising a sensor and a spatial subsystem, comprising the steps of:

a) measuring a quantity with the sensor over the selected spatial region;

b) measuring spatial information with the spatial subsystem at a time substantially simultaneous with the measurement of the quantity, the spatial information comprising one of a position of the device relative to a reference position, an orientation of the device relative to a reference orientation, and a combination thereof;

c) repeating steps (a)-(b) one or more times within the selected spatial region; and

d) providing, based on a dataset comprising measurements of the quantity made by the sensor and the spatial information, a determination of the quantity over the selected spatial region.

In a preferred embodiment, the device may be employed by a user to generate spatially or directionally-correlated thermal, distance, or other data by translating and/or rotating a device in space, with the device pointed generally towards the area or object of interest.

A further understanding of the functional and advantageous aspects of the invention can be realized by reference to the following detailed description and drawings.

### BRIEF DESCRIPTION OF THE FIGURES

The embodiments of the present invention are described with reference to the attached figures, wherein:

FIG. 1 shows an illustration of an example environment: a park outside with picnic tables and trees on a sunny day. Note the trees are casting large shadows.

FIG. 2 shows an example walking path through the environment illustrated in FIG. 1. The path is arbitrary—both positional data and image data are recorded continuously along the path. All points on the image need not be sampled, as any points not sampled can be extrapolated.

FIG. 3 shows an example “top-down map” type image, showing variations in the ambient temperature in the park illustrated in FIG. 1. Note the regions under the trees within their shadows appear cooler.

FIG. 4 shows an exemplary environment, containing a heat source (a fireplace).

FIG. 5 shows an example arbitrary scan pattern overlaid upon the exemplary environment.

FIG. 6 shows a sample image generated from the sample dataset of Table 1.

FIG. 7 shows an illustration of a sample scene where an LCD monitor is sitting on a desk.

FIG. 8 shows a “picture” type image of linear polarization of the desk, and LCD monitor scene depicted above. The grayscale regions represent areas of linear polarization, where white regions represent unpolarized regions.

FIG. 9 shows the user (holding the device) standing in a room of unknown dimensions.

FIG. 10 schematically shows a series of measurements obtained while the user rotates 360°, with the device. While rotating, the device records 3D position and orientation information, as well as the distance to the wall in the direction that it's pointing.

FIG. 11 shows a “spatial projection” image generated by the system, displaying a top-down floor plan of the room with the dimensions of each wall extrapolated and labeled.

### DETAILED DESCRIPTION OF THE INVENTION

Generally speaking, the device and methods described herein are directed to the measurement of a quantity over a selected spatial region. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to devices and methods for measuring a quantity over a selected spatial region.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

As used herein, the phrase “measured quantity” refers to a measurement of a quantity, property, or value by a sensor. The quantity may be any type of quantity that can be measured by a sensor, including, but not limited to, physical, spatial, optical, chemical, biological, acoustic, thermal, temporal, electrical, magnetic, electromagnetic, and nuclear quantities.

As used herein, the coordinating conjunction “and/or” is meant to be a selection between a logical disjunction and a logical conjunction of the adjacent words, phrases, or clauses. Specifically, the phrase “X and/or Y” is meant to be interpreted as “one or both of X and Y” wherein X and Y are any word, phrase, or clause.

In a first embodiment, the present invention provides a method for obtaining a determination of a quantity over a selected spatial region, based on a set of measurements of the quantity using a device that includes both a sensor for performing the measurement, and a spatial subsystem adapted to provide spatial orientation and/or spatial position information.

The method according to the invention is preferably performed as follows. The device, which incorporates a sensor for performing a measurement of a quantity, property or value, and a spatial subsystem for determining spatial information including orientation and/or position information, is employed to measure both the quantity and spatial information at various locations within the selected spatial region. When each measurement is made, the spatial information is determined at approximately the same time, thereby producing a correlated data point that includes both the measured quantity and the spatial information pertaining to the device. After a sufficient or pre-determined number of measurements have been made, the resulting dataset of measured data and spatial information is provided to a processor. The processor operates on the dataset to generate a determination of the measured quantity over the selected spatial region.

The spatial subsystem preferably includes sufficient sensors for the determination of the spatial position of the device relative to a reference position, and/or an orientation of the device relative to a reference orientation. The spatial subsystem may include a gyroscope, accelerometer, and/or global position system (GPS) device, and preferably includes a 3-axis gyroscope and a 3-axis accelerometer. In another embodiment, the device also includes a magnetometer for correcting errors in gyroscope readings. Other spatial and inertial systems and devices known in the art may also be incorporated in the device.

The device preferably includes a user interface for entering commands (such as initiating a particular measurement). The user may configure the device to initiate measurements in a number of different formats, for example, continuously (e.g. at fixed time intervals) or in response to a user action. The device further includes a power source, an enclosure, and a processing subsystem for the recording, analysis and storage of pre- and post-processed data and results. In a preferred embodiment, the processing subsystem is integrated directly into the device, and the resulting determination of the quantity over the selected spatial region is displayed to the user on a display integrated into the device.

The processing subsystem preferably includes a microcontroller or microprocessor and a memory device such as flash memory. In another embodiment, the microprocessor may be an application specific integrated circuit or a field programmable gate array.

In an alternative embodiment, the device may also include a communication subsystem that facilitates the transmission, or the transmission and reception, of data to a remote processor, such as a computer or server. The communications subsystem is preferably a wireless transmitter or a wireless transceiver, and may employ protocols such as the IEEE 802.11 wireless standard. In a preferred embodiment, the processing subsystem residing in the device only provides minimal pre-processing of data (for example, the packaging of data into an arrangement facilitating subsequent transmission) and the detailed processing, analysis, and presentation of results is provided by a remote processor.

The processing subsystem according to the invention operates on the dataset to provide a determination of the measured quantity over the selected spatial region. In one embodiment, the processor generates a graphical display of the measured data points in a spatial representation corresponding to the selected spatial region. In a preferred embodiment, the processor interpolates the discrete set of measured data, and provides an interpolated set of points that each includes a calculated value of the quantity (based on the interpolation) and a spatial coordinate corresponding to the calculated value of the quantity. The interpolated set of points may be displayed by the device on a display, showing the interpolated values of the quantity over the selected spatial region.

In the preceding embodiment comprising interpolating the measured data, any interpolation algorithm known in the art may be employed. In preferred embodiment, the interpolation is achieved using linear interpolation, whereby an interpolated coordinate is spatially inserted on a line connecting two existing coordinates, and a interpolated value of the quantity at the new coordinate is obtained using a linear interpolation of the values of the quantity at the two existing coordinates. This process of inserting data points and calculating linear interpolated values can be repeated multiple times to generate a new spatial determination of the quantity with increased spatial density. Other interpolation methods known in the art may also be employed, such as polynomial or spline interpolation, and wavelet methods.

During operation, the device preferably presents the user with a software user interface allowing the user to select one or more sensors for a measurement, or a combination of sensors to “fuse” during the measurement process. The user interface preferably also includes a display for presenting the results of a given measurement. The device actively samples the readings from the sensors attached to the device, places them through an appropriate sensor fusion algorithm (such as the exemplary interpolation algorithm described above), and presents the resulting output of the sensor fusion algorithm to the user. Depending on the specific combination of sensors selected, the user may be required to physically move the handheld device in space or around an environment in order to generate the desired data.

In a preferred embodiment, the device is handheld, and determination of the measured quantity is obtained by varying the spatial position and/or angular orientation of the device within the selected spatial region while actively measuring the quantity with the sensor.

In a preferred embodiment of the invention, the device includes a single pixel sensor that generates a single measurement at a given instant in time. The single pixel sensing device may be implemented in a number of different embodiments according to the invention. These embodiments depend on the directionality of the sensor and the degrees of freedom of motion and orientation of the device.

In one embodiment, the sensor does not have a specific field of view, and provides a local measurement of a quantity (e.g. temperature) in the vicinity of the device. In this embodiment, the orientation of the device is not relevant, and the spatial subsystem need only incorporate sensors for determining the relative translation of the device. Such sensors could include, for example, a GPS device and/or one or more accelerometers.

This embodiment also enables the generation of a “top-down map”, in which measurements within a substantially two-dimensional planar region may be viewed from the top-down similar to a terrain or geographical map. For example, measurements of a quantity may be obtained by translating the sensor around a room, or walking in an arbitrary pattern around an outdoor field. In a specific example, the sensor may be a magnetometer, and a user may walk around a large open field to map the changes in ambient magnetic readings, potentially correlating to underground ferrous mineral deposits.

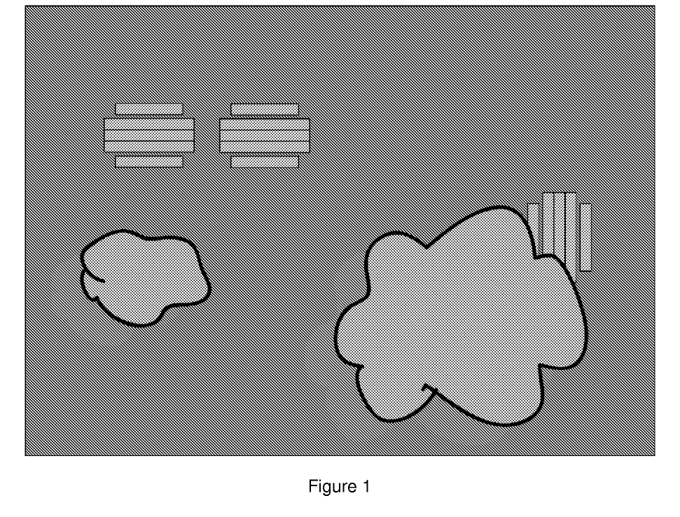

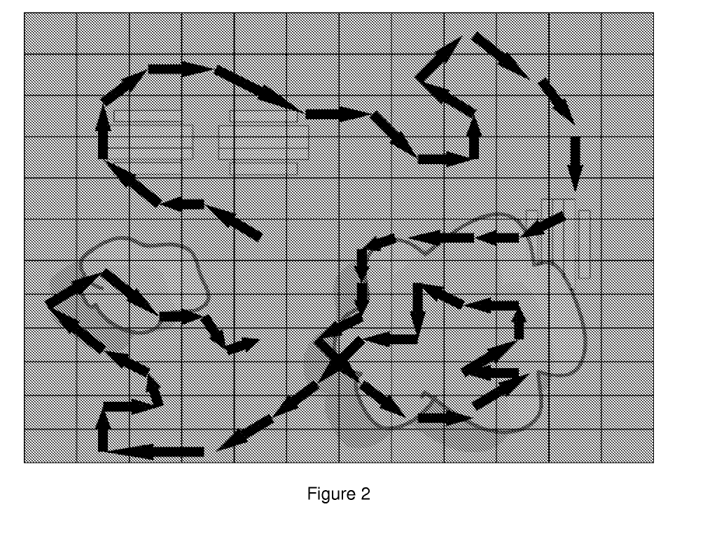

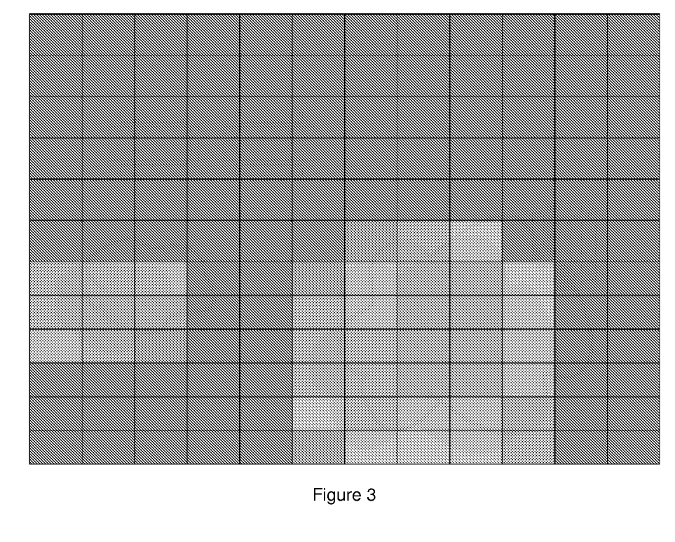

An example of this embodiment is shown in FIGS. 1-3, in which a coarse temperature map is determined according to one aspect of the invention. FIG. 1 shows, from an overhead perspective, an outdoor environment including several trees casting shadows. An overhead thermal image is obtained by translating the device throughout the selected spatial region and measuring the local temperature. FIG. 2 shows the path taken by a user holding the device, and an overlay of discrete cells in which the temperature is to be measured and/or determined. FIG. 3 shows a thermal image produced by the device based on the dataset comprising the measured temperatures and the correlated spatial information.

This embodiment is preferably suited to omnidirectional sensors that include the following non-limiting examples: 3-axis magnetometer sensors, ambient atmospheric temperature sensors, ambient atmospheric pressure sensors, microphones, and ambient atmospheric humidity sensors. As noted above, this embodiment enables the measurement of top-down images such as an ambient atmospheric pressure image of a house or building, showing areas of high and low pressure.

In another embodiment of the invention, the sensor is directional and is characterized by an angular field of view, and the spatial subsystem includes sensors for determining the orientation of the device (and optionally further includes sensors for determining the spatial position of the device). The device is preferably operated by varying the angular orientation of the device from a substantially fixed location in space, thereby generating an angular image of the measured quantity. Accordingly, in this embodiment, a variation in the orientation of the device allows one to sample a given field-of-view in the direction of an object or environment of interest. In one embodiment, spatial position sensors are employed to correct and/or compensate for translational motion of the device while varying the angular orientation of the device.

This embodiment is well suited to sensors that have a particular field of view. Exemplary sensors include, but are not limited to, non-contact temperature sensors, colour sensors, linear polarization sensors, and directional sound level sensors. They may be coupled with a distance sensor in order to appropriately adjust their field-of-view on the image depending on how far the device is from a given object.

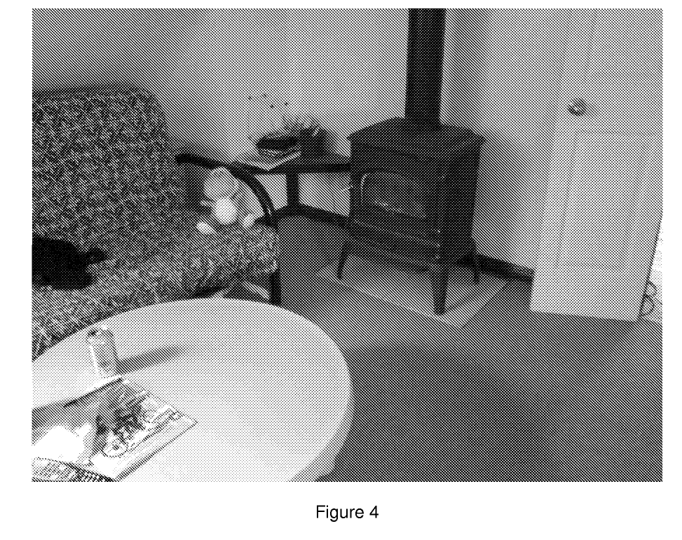

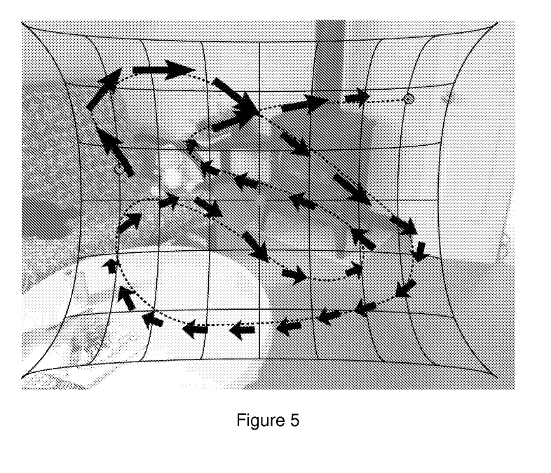

An example of this embodiment, involving the directional measurement of temperature, is illustrated in FIGS. 4-6. FIG. 4 shows a selected spatial region including a portion of a room. In FIG. 5, a two-dimensional grid is overlaid on the spatial region, denoting a set of cells where individual thermal measurements may be determined by varying the angular orientation of the device. The device includes a thermal sensor with an angular field of view of 10°. The spatial subsystem of the device provides a determination of the orientation of the device in space and allows a measurement of temperature to be correlated with the spatial information. By varying the orientation (and optionally the position) of the device, a thermal image of an area can be constructed, where the image comprises a set of measured quantities and corresponding spatial coordinates.

To determine the temperature profile over the spatial region, the angular direction of the device is varied and a measurement is obtained, preferably, but not necessarily, within each cell in FIG. 2 (an interpolation, extrapolation, or other algorithm known in the art may be used in conjunction with the processing subsystem of the device to estimate or determine the value of the quantity in skipped cells). The angular scan path of the device is shown in FIG. 5, and corresponds to an arbitrary scan pattern produced by freely scanning the angular orientation of a handheld device. The results of individual measurements within the cells are shown below in Table 1.

TABLE 1
Sample dataset from the scan pattern shown in FIG. 5.

| | | Non-contact | |
|---|---|---|---|
| | | Temperature | |
| Pan (left-right) | Tilt (up-down) | Reading (° C.) | Notes |
| −37.5° | 7.5° | 20° C. | Start |
| −52.5° | 22.5° | 20° C. | |
| −37.5° | 37.5° | 20° C. | |
| −22.5° | 37.5° | 20° C. | |
| −7.5° | 37.5° | 20° C. | |
| 7.5° | 22.5° | 81° C. | Fireplace |
| 22.5° | 7.5° | 90° C. | Fireplace |
| 37.5° | −7.5° | 20° C. | |
| 52.5° | −7.5° | 20° C. | |
| 52.5° | −22.5° | 20° C. | |
| 37.5° | −22.5° | 20° C. | |
| 22.5° | −37.5° | 20° C. | |
| 7.5° | −37.5° | 20° C. | |
| −7.5° | −37.5° | 25° C. | Table |
| −22.5° | −37.5° | 23° C. | Table |
| −37.5° | −37.5° | 22° C. | Table |
| . . . | . . . | . . . | |
| . . . | . . . | . . . | |
| . . . | . . . | . . . | |
| 22.5° | 22.5° | 83° C. | Fireplace |
| 37.5° | 22.5° | 35° C. | Fireplace, End |

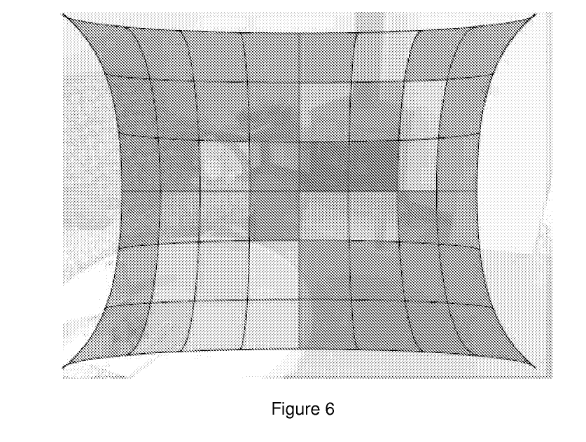

This dataset could then be used to generate an image, either by a 1:1 mapping or through a statistical or sensor fusion algorithm such as an interpolating algorithm. FIG. 6 shows the result of a series of measurements with the device, in which a coarse image of the temperature has been plotted over the selected spatial region. This image may be displayed directly on the device, or the dataset may be transmitted to a remote processor or computer for remote analysis and display.

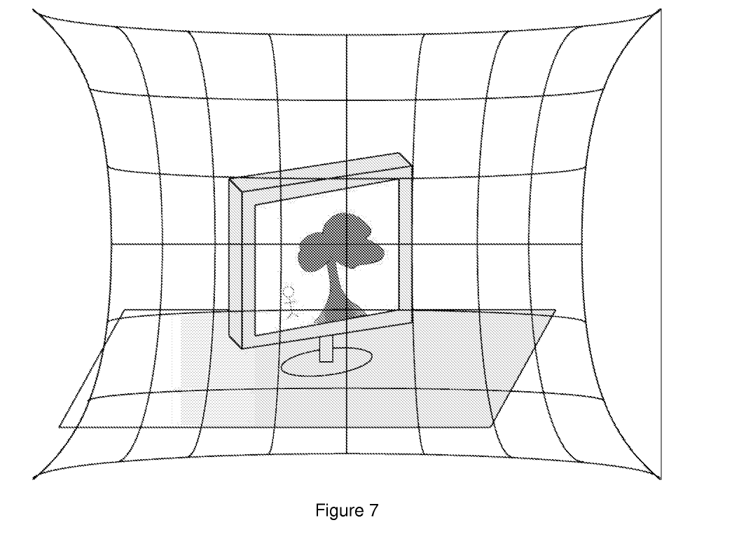

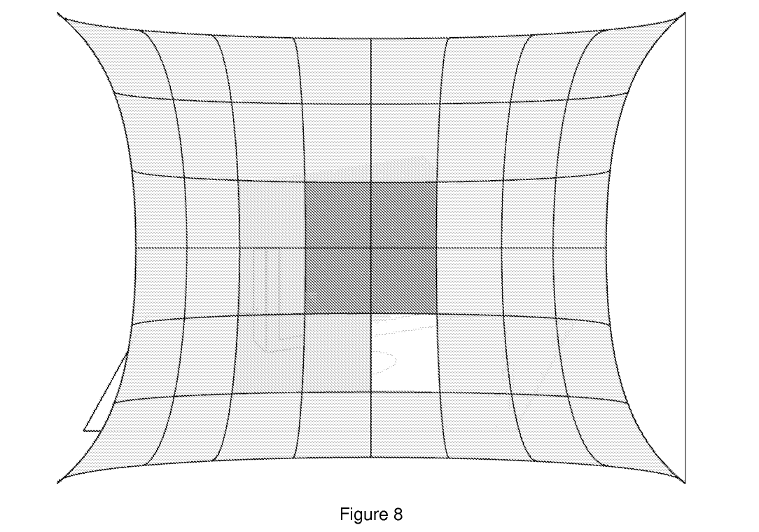

Another example of this embodiment is provided in FIGS. 7 and 8. FIG. 7 shows a selected spatial region including a computer monitor positioned on a table. A device according to the invention, incorporating a directional polarization sensor with a spatial subsystem, is scanned in an angular pattern and measures the angle-resolved intensity of incident light along a specific polarization direction. The resulting polarization map over the selected region of interest is shown in FIG. 8.

In a preferred embodiment, the device includes a sensor that provides a non-local measurement of a quantity in a specific direction relative to the device, and the device further includes a distance sensor for the measurement of the distance between the device and an object along the specific direction. For example, the sensor may be a thermal sensor capable of measuring the temperature at a point on a distant object. Preferably, both the position and the orientation of the device may be varied, and the device is handheld with full spatial degrees of freedom in translation and orientation. Alternatively, the device may be mounted on a robotic system, for example, in an industrial setting.

For example, a subset of the sensors incorporated in the device may include: a triple-axis accelerometer, a triple-axis gyroscope, a non-contact temperature sensor capable of giving an average temperature reading for some field of view from that sensor, and an ultrasonic distance sensor. The user may select that they would like to view data coming from the noncontact temperature sensor, and would like this data continuously plotted on a two or three-dimensional representation of the selected spatial region.

The results showing the determination of the measured temperature over the selected spatial region could be plotted in a number of different ways. For example, the user could select that the resulting data be plotted based on the output of the spatial subsystem formed by the combination of the triple-axis gyro and triple-axis gyroscope. The user could then select that the size of the dot or data point on the image would be determined by the measured distance by the ultrasonic distance sensor; for example, that closer distances will show larger dots, and father distances will show smaller dots.

In this preferred embodiment, the device allows similar datasets to be generated as in the previous embodiment involving the angular scanning of the device. However, instead of containing only orientation information, the device makes use of the inertial measurement unit to generate datasets tagged with full 3-dimensional position (x, y, z position) and orientation (pitch, yaw, roll) information.

Thus, while the device is capable of generating the same information as in the angular scanning example above, there are several differences in the devices operation:

(1) the device is handheld and the user may freely translate and orient the device in an arbitrary scan pattern using their own hand movements. This is detected using the 3-axis accelerometer and 3-axis gyroscope in the inertial measurement unit;

(2) the device is capable of being freely moved in space;

(3) the device does not directly take images (as in the case of a pan-tilt head with a camera mounted atop), but rather generates datasets as a consequence of its motion through space which are then used to generate spatial images; and

(4) The datasets have a richer set of 3-dimensional position and orientation data, allowing more complex images or 3D reconstructions to be created from the data.

In a preferred embodiment, a device according to the invention allows the generation of three-dimensional images, or three-dimensional models, based on a discrete number of single-pixel measurements. Preferably, the device should be translated (in the case of a non-directional sensor) or translated and oriented (in the case of a device incorporating a directional sensor and a distance measuring sensor) to provide a measurement of the quantity over the range of interest with desired resolution. In a preferred embodiment, the resulting determination of the quantity is displayed in a spatial format in which the perspective is dynamic and user-selectable. For example, a device according to the invention may be adapted to generate a low-resolution three-dimensional model of a fireplace, where the model's colour at a given point would reflect its temperature. Similarly, a device according to the invention could generate a low-resolution three-dimensional map of a room, where the mapped quantity could include, for example, the temperature, pressure, or humidity of the room at any given point sampled.

In a related embodiment, a device according to the invention may provide a spatial determination of the location of objects based on a number of discrete spatial measurements. For example, a device may incorporate a distance sensor (such as an ultrasonic or optical distance sensor) with a spatial subsystem, allowing a user to measure the floor plan of a room by standing in the center of a room and rotating 360° while pointing the device towards the walls of the room.

While the measurements may be made simply by rotation of the device, it may be necessary to include positional movement if room is sufficiently large or irregularly shaped. After obtaining a sufficient number of distance measurements, the dataset incorporating distance measurements and spatial information is provided to the processor, which determines the spatial location of the room perimeter using an algorithm.

In a preferred algorithm, the perimeter or floor plan of a room is obtained by locating walls and determining their intersection. The dataset, obtained by the combination of the distance measurements and the spatial information, provides the coordinates of measured points on the walls of the room. Individual walls are identified by linear fitting adjacent points to lines. Terminal points are calculated by determining the point of intersection of the lines, thereby enabling the determination of the walls and the construction of a floor plan.

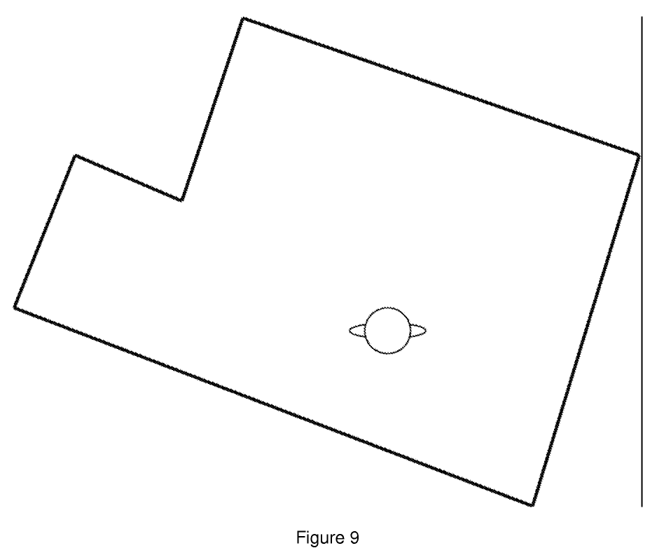

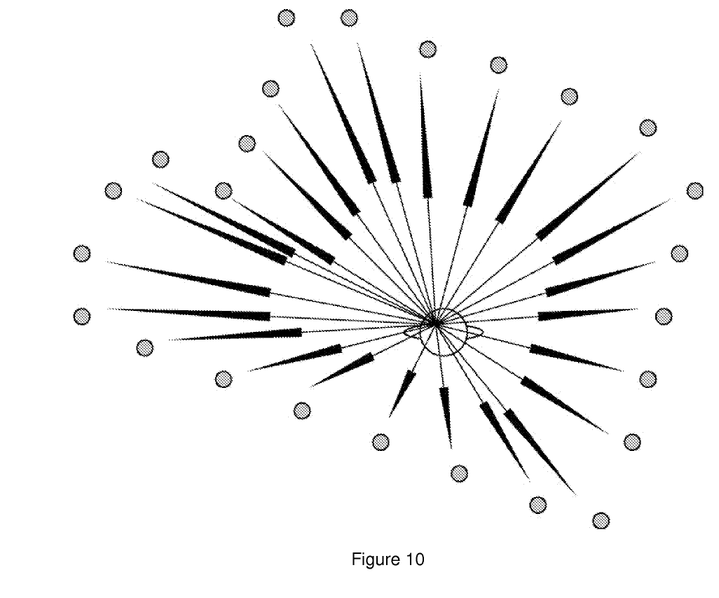

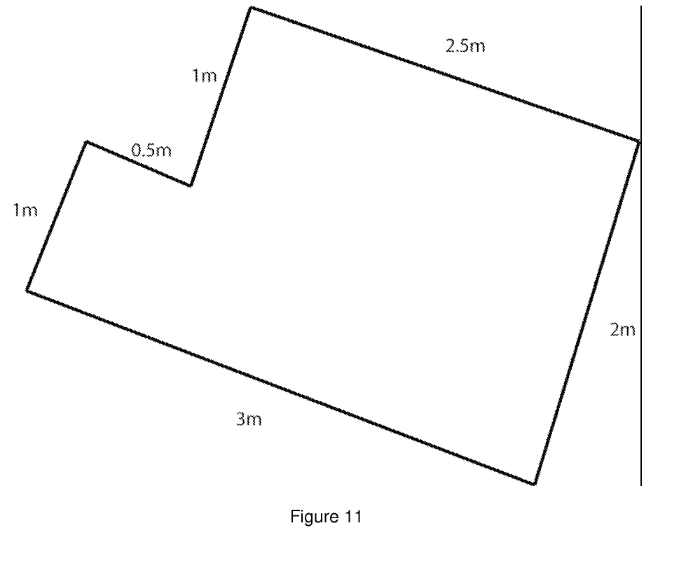

This embodiment is schematically shown in FIGS. 9-11. FIG. 9 shows a room of unknown dimensions and a device according to the present invention located in the room. The rotation and measurement of specific distances by the device is illustrated in FIG. 10. The resulting measured floor plan, complete with measured wall segments, is provided to the user as shown in FIG. 11.

In a preferred embodiment, the present invention provides a device for image generation. The device preferably includes sensors that are directional and characterized by a field of view. Exemplary sensors include non-contact temperature sensors, ultrasonic distance measurement sensors, colour sensors, 3-axis magnetic field strength and direction sensors, polarization sensors capable of determining the linear polarization angle of incident light, ambient atmospheric temperature sensors, an ambient atmospheric humidity sensors, ambient atmospheric pressure sensors, and directional sound-level sensors or microphones.

In the preceding embodiments of the invention involving a single pixel non-contact thermal sensor, the device according to the invention allows a user to progressively generate a low-resolution thermal image. Where a traditional two-dimensional image (using a thermal camera) is generated from a two-dimensional array of light sensors, and is thus generated very quickly, the sensor fusion thermal image described above would generate one point on the image at a time. The single-pixel image, while taking longer to generate than an image with a traditional two-dimensional array imager, has the benefit of being able to use inexpensive sensors to generate a similar, lower resolution output to a traditional two-dimensional imager.

Despite the aforementioned advantages of a device incorporating a single pixel sensor, there may be many applications in which it may be advantageous to utilize a multi-element sensor in a device according to the invention. Accordingly, the present invention also includes embodiments involving sensor arrays, whereby a given measurement produces an array of measured data points. As in previous embodiments, a device incorporating an array of sensors further includes a spatial subsystem, where spatial information relating to the position and/or orientation of the device is provided by the spatial subsystem at a time that is approximately simultaneous with a given measurement by the array.

The dataset generated by a device incorporating an array sensor includes a set of data arrays, with each data array comprising an array of measurements and spatial information corresponding to the array. However, in addition, the dataset further includes information regarding the relative spatial and/or orientation of each element in the array. The processor subsystem then uses this relative spatial and orientation information to generate the determination of the quantity based on the multiple array measurements. For example, the processor may be adapted to stitch, average, and/or interpolate multiple array measurements to provide a composite determination of the measured quantity over the selected spatial region. Furthermore, while the preceding embodiments of the invention involve a device with a single measuring sensor and a spatial subsystem, the present invention further contemplates devices with more than one measuring sensor, where each sensor preferably measures a unique quantity. In one embodiment, the device may be adapted to measure multiple quantities concurrently with the sensors, while also generating datasets containing multiple sensor measurements as well as spatial position and orientation information, as in the preceding single sensor embodiments. In another embodiment, the user may select one specific sensor for determining a specific quantity over a selected spatial region. For example, depending on the type of measurement that the user wishes to generate, the user will may (a) select the ‘image generation’ sensor they wish to use, and (b) translate and/or orient the device in a specific pattern that will generate a dataset conducive to creating the selected image type. In a preferable embodiment, the device is reconfigurable and sensors modules may be added or removed by the user. In a preferred embodiment, the sensor modules are hot-swappable, with the device recognizing and/or auto-calibrating newly inserted sensors.

In another embodiment, the device may further include a measurement of absolute time or a time delay relative to a reference time (e.g. using a chronometer), for time stamping of individual measurements and/or the determination of a velocity or acceleration of the device.

Specific novel features of the present invention include the following:
A handheld device that serves as a platform for sensor fusion to take place
A device, as above, that contains a variety of sensors that are removable and reconfigurable
A device, as above, that allows a user to easily select a combination of sensors to fuse, and the specific method that they be combined. This includes high-level features such as the desired output (i.e. a painting interface image made using a given sensor), or low-level features (such as the specific sensor-fusion algorithm to use to generate the data).
A device, as above, allowing its output to be displayed to the user on a display device present on the handheld instrument itself
A device, as above, allowing its output to be stored for later retrieval on a an internal fixed medium, or removable medium
A device, as above, allowing its output to be transmitted to another device, as in wirelessly communicating its output to a nearby desktop computer or laptop
The method of generating a thermal or other image based on a “painting” interface

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A measurement device comprising:
a sensor;
a spatial subsystem for determining, at a time substantially simultaneous with a measurement of a quantity by said sensor, spatial information comprising one of a position of said device relative to a reference position, an orientation of said device relative to a reference orientation, and a combination thereof;
a power source;
a user interface;
a housing; and
a processing subsystem comprising a processor and memory;
wherein said processing subsystem is adapted to provide, based on a dataset comprising measurements of said quantity made by said sensor and said spatial information provided by said spatial subsystem, a determination of said quantity over a selected spatial region.

2. The device according to claim 1 wherein said spatial subsystem comprises one or more spatial and inertial sensors selected from the list comprising an accelerometer, a magnetometer, a gyroscope, and a global positioning system.

3. The device according to claim 1 wherein said sensor is adapted to provide a single measurement at a given point in time.

4. The device according to claim 1 wherein said sensor is adapted to provide an array of measurements at a given point in time, wherein said array of measurements corresponds to one of an array of spatial directions, and array of spatial positions, and a combination thereof.

5. The device according to claim 1 wherein said sensor is adapted to measure said quantity locally at a location corresponding to said device.

6. The device according to claim 5 wherein sensor is further adapted to measure said quantity in a selected direction relative to said device.

7. The device according to claim 1 wherein said sensor comprises a distance sensor, wherein a distance along a pre-selected direction relative to said device, between said device and an object, is measured.

8. The device according to claim 1 wherein said device further comprises a distance sensor, wherein a distance along a pre-selected direction relative to said device, between said device and an object, is measured at a time substantially simultaneous with a measurement made by said sensor, and wherein said dataset further comprises a measurement of said distance.

9. The device according to claim 1 wherein said determination of said quantity over a selected spatial region comprises a discrete set of measurements made by said sensor.

10. The device according to claim 1 wherein said determination of said quantity over a selected spatial region is obtained by spatially interpolating said measurements made by said sensor.

11. The device according to claim 1 wherein said sensor measures a quantity selected from the list comprising optical, electromagnetic, spatial, magnetic, acoustic, distance, thermal, chemical, biological, nuclear, temporal, and electrical quantities.

12. The device according to claim 1 further comprising one or more additional sensors, wherein each additional sensor is adapted to measure a quantity, wherein said processing subsystem is adapted to provide, based on a set of measurements made by said sensors and spatial information provided by said spatial subsystem, a determination of said quantities over said selected spatial region.

13. The device according to claim 12 wherein a user may select a single sensor for the determination of a single quantity over a selected spatial region.

14. The device according to claim 1 further comprising a chronometer, wherein said device provides, at a time substantially simultaneous with a measurement made by said sensor, a measurement of one of an absolute time or a time delay relative to a reference time.

15. The device according to claim 1 further comprising a display.

16. The device according to claim 1 further comprising a communication subsystem, wherein one of said dataset, said determination of said quantity over a selected spatial region, and a combination thereof may be transmitted to a remote processing system.

17. The device according to claim 16 wherein said communication subsystem comprises one of a wireless transmitter and a wireless transceiver.

18. The device according to claim 1 comprising a handheld device.

19. The device according to claim 1 wherein said device is mounted to a system adapted for one of rotation, translation, and a combination thereof.

20. A method of measuring a quantity over a selected spatial region with a device comprising a sensor and a spatial subsystem, comprising the steps of:
a) measuring a quantity with said sensor within said selected spatial region;
b) measuring spatial information with said spatial subsystem at a time substantially simultaneous with said measurement of said quantity, said spatial information comprising one of a position of said device relative to a reference position, an orientation of said device relative to a reference orientation, and a combination thereof;
c) repeating steps (a)-(b) one or more times within said selected spatial region; and
d) providing, based on a dataset comprising measurements of said quantity made by said sensor and said spatial information, a determination of said quantity over said selected spatial region.

21. The method according to claim 20 wherein said spatial subsystem comprises one or more spatial and inertial sensors selected from the list comprising an accelerometer, a magnetometer, a gyroscope, and a global positioning system.

22. The method according to claim 20 wherein a single measurement is obtained from said sensor at a given point in time.

23. The method according to claim 20 wherein an array of measurements is obtained from said sensor at a given point in time, wherein said array of measurements correspond to one of an array of spatial directions, and array of spatial positions, and a combination thereof.

24. The method according to claim 20 wherein said quantity is locally measured at a location corresponding to said device.

25. The method according to claim 24 wherein sensor is further adapted to measure said quantity in a selected direction relative to said device.

26. The method according to claim 20 wherein said sensor comprises a distance sensor, wherein a distance along a pre-selected direction relative to said device, between said device and an object, is measured in step (a).

27. The method according to claim 20 wherein said device further comprises a distance sensor, wherein a distance along a pre-selected direction relative to said device, between said device and an object, is measured at a time substantially simultaneous with a measurement made by said sensor in step (a), and wherein said dataset further comprises a measurement of said distance.

28. The method according to claim 20 wherein said step of providing a determination of said quantity over a selected spatial region comprises providing a discrete set of measurements made by said sensor.

29. The method according to claim 20 wherein said step of providing a determination of said quantity over a selected spatial region is obtained by spatially interpolating said measurements made by said sensor.

30. The method according to claim 20 wherein said step of measuring a quantity with said sensor comprises measuring a quantity selected from the list comprising optical, electromagnetic, spatial, magnetic, acoustic, distance, thermal, chemical, biological, nuclear, temporal, and electrical quantities.

31. The method according to claim 20 further comprising, in step (a), measuring one or more additional quantities with one or more additional sensors, wherein in step (d), a determination of said quantities is provided over said selected spatial region.

32. The method according to claim 31 wherein a user may select a single sensor for the determination of a single quantity over a selected spatial region.

33. The method according to claim 20 further comprising measuring, at a time substantially simultaneous with a measurement made by said sensor, temporal information comprising an absolute time or a time delay relative to a reference time.

34. The method according to claim 33 wherein in step (d), said spatial information and said temporal information are included in said dataset and one of a velocity of said device, an acceleration of said device, or a combination thereof is determined at the time of each said measurement.

35. The method according to claim 20 further comprising providing said determination of said quantity over said selected spatial region to a user on a display.

36. The method according to claim 20 further comprising transmitting one of said dataset, said determination of said quantity over a selected spatial region, and a combination thereof to a remote processing system.

37. The method according to claim 20 wherein said measurements are obtained at fixed time intervals.

38. The method according to claim 20 wherein said measurements are performed when initiated by a user.

39. The method according to claim 20 wherein said quantity comprises a spatial location of one or more walls, and wherein said determination of said quantity over a selected location comprises a determination of said spatial location of one or more walls over said selected spatial region.
